(19) United States
(12) Patent Application Publication
(10) Pub. No.: US 2005/0132178 A1
(43) Pub. Date: Jun. 16, 2005

(54) Removable flash backup for storage controllers

(76) Inventor: Sridhar Balasubramanian, Wichita, KS (US)

Correspondence Address: LSI Logic Corporation;Legal Department - IP, 1621 Barber Lane, MS D-106, Milpitas, CA, 95035, US

(21) Appl. No.: 10/735,160

(22) Filed: Dec. 12, 2003

(51) Int. Cl. G06F 9/00; G06F 12/16

(52) U.S. Cl. 713/1; 711/162

(57) ABSTRACT

A memory interface adapter is provided in a storage controller for accepting a removable non-volatile memory module, such as a flash memory. The removable non-volatile memory module may be inserted or removed through an external facing of the storage controller. Software on the storage controller, such as controller firmware, includes functionality for performing backup and restore operations to and from the removable memory module. A save operation saves configuration data, current firmware images, and/or bootware images to the removable non-volatile memory module. Configuration information to be stored may be user selectable. The removable non-volatile memory module may be removed from one storage controller and inserted into another storage controller. A restore operation restores the configuration information from the removable non-volatile memory module to a storage controller. Migration rules may be applied to ensure compatibility with the storage controller when performing a restore operation.

### BACKGROUND OF THE INVENTION

1. Technical Field

The present invention relates to storage controllers and, in particular, to storage controllers for storage systems. Still more particularly, the present invention provides a method, apparatus, and program for providing removable flash backup for storage controllers.

2. Description of the Related Art

Redundant array of independent disks (RAID) is a disk subsystem that is used to increase performance and provide fault tolerance. RAID is a set of two or more ordinary hard disks and a specialized disk controller, referred to as a RAID controller, that contains the RAID functionality. RAID can also be implemented via software only, but with less performance, especially when rebuilding data after a failure.

A storage controller, such as a RAID controller, has a set of configuration information that allows the controller to operate in a manner that is compatible with storage devices and performs at a user-definable level. This configuration information may include, for example, configuration data, firmware, bootware images, and component summary data. This configuration information is stored within the storage controller in a non-volatile memory, such as flash memory or non-volatile static random access memory (NVSRAM).

When a disaster occurs, the configuration information may become inaccessible or corrupted. For example, when a storage controller fails, it may be replaced with a new storage controller. Typically, the configuration information must be rebuilt in the new controller. The configuration data may be inadvertently wiped, by a system wipe, for example. As another example, a wrong firmware may be loaded, which may corrupt the configuration data. Furthermore, configuration save and restore operations are not supported for some premium features like remote volume mirroring (RVM). Only volume level restore operations are supported.

### SUMMARY OF THE INVENTION

The present invention recognizes the disadvantages of the prior art and provides a removable flash memory backup for storage controllers. A memory interface adapter is provided in a storage controller for accepting a removable non-volatile memory module, such as a flash memory. The removable non-volatile memory module may be inserted or removed through an externally accessible socket interface of the storage controller. Software on the storage controller, such as controller firmware, includes additional functionality for performing backup and restore operations to and from the removable memory module. A save operation saves configuration data, current firmware images, and/or bootware images to the removable non-volatile memory module. Configuration information to be stored may be user selectable. The removable non-volatile memory module may be removed from one storage controller and inserted into another storage controller. A restore operation restores the configuration information from the removable non-volatile memory module to a storage controller. Migration rules may be applied to ensure compatibility with the type and model of storage controllers when performing a restore operation.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a pictorial representation of a storage controller enclosure in accordance with a preferred embodiment of the present invention;

FIG. 2 illustrates an example storage network configuration in accordance with a preferred embodiment of the present invention;

FIG. 3 is a block diagram illustrating a storage controller in accordance with a preferred embodiment of the present invention; and

FIG. 4 is a flowchart illustrating the operation of a flash backup and restore utility within a storage controller in accordance with an exemplary embodiment of the present invention.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

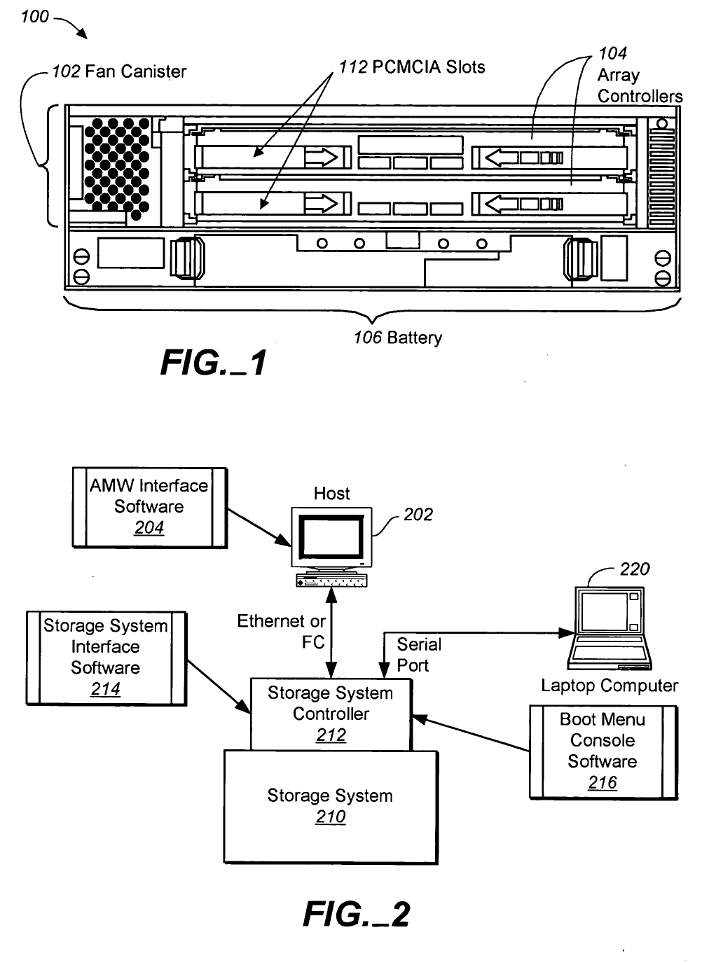

With reference now to the figures and in particular with reference to FIG. 1, a pictorial representation of a storage controller enclosure is shown in accordance with a preferred embodiment of the present invention. Storage controller enclosure 100 includes fan canister 102, which houses a fan for cooling components of the storage controllers. Enclosure 100 also includes array controllers 104. In the depicted example, two storage controllers, array controller A and array controller B, are included. Array controller A may control a first redundant array of independent disks (RAID) and array controller B may provide redundancy to controller A. Battery 106 provides standby power to the components in storage controller enclosure 100, in the event of power outage.

In accordance with a preferred embodiment of the present invention, storage controllers 104 include Personal Computer Memory Card International Association (PCMCIA) card slots 112. Removable non-volatile memory modules, such as flash memory modules, may be inserted in PCMCIA card slots 112 for backup and restore of configuration information for array controllers 104. For example, if array controller A fails, it may be replaced with a new controller that also has a PCMCIA card slot. The removable non-volatile memory module may be removed from the failed controller and inserted into the replacement controller. A restore operation may be performed to restore saved configuration information from the removable non-volatile memory module to the new controller.

FIG. 2 illustrates an example storage network configuration in accordance with a preferred embodiment of the present invention. Host 202 connects to storage system 210 through storage system controller 212. The host is connected to the storage controller through a communications medium, such as Ethernet or Fibre Channel (FC). Storage controller 212 also has a serial port through which an external device, such as laptop computer 220, may be connected.

Storage system 210 may be, for example, a redundant array of independent disks (RAID) and, thus storage controller 212 may be a RAID controller. In the depicted example, storage system controller 212 includes storage system interface software 214, which provides a software interface between the storage system and the host. The storage system interface software may be, for example, the SYMbol interface from LSI Logic Corporation. Administrative management window (AMW) interface software 204 resides on host 202. The AMW may be, for example, SANtricity host software from LSI Logic Corporation. A user may also connect to the storage controller from a device, such as host 202, using a telnet session, for example. The storage controller may also include boot menu console software 216. The user then may boot up the storage controller and enters the boot menu console for the controller.

In accordance with a preferred embodiment of the present invention, storage system controller 212 includes at least one adapter for a removable non-volatile memory module. Through the AMW interface software 204 or boot menu console software 216, an operator may invoke backup and restore commands. Using a backup command, configuration information is stored to a removable non-volatile memory module inserted in storage system controller 212. Configuration information may include, for example, configuration data, firmware, bootware images, and component summary data.

If the storage system controller fails or configuration information in the controller is lost or otherwise corrupted, the removable non-volatile memory module may be used to restore the configuration information. For example, is storage system controller 212 fails, it may be replaced with a new storage system controller that also has an adapter for a removable non-volatile memory module. The memory module may then be removed from the failed controller and inserted into the replacement controller. Using a restore command, configuration information is restored from the memory module to the storage system controller.

An operator may also use AMW interface software 204 or boot menu console software 216 to set parameters for operation of storage system controller 214. More particularly, an operator may set the configuration information to backup, migration rules for restoring configuration information, a frequency for performing automatic periodic backups, and the like. Feedback may also be presented to the operator through AMW interface software 204 or boot menu console software 216. For example, an operator may be notified that a backup or restore operation cannot be performed because a removable non-volatile memory module is not inserted in the storage system controller. An operator may also be notified if a replacement controller is not compatible with configuration information stored on a removable non-volatile memory module.

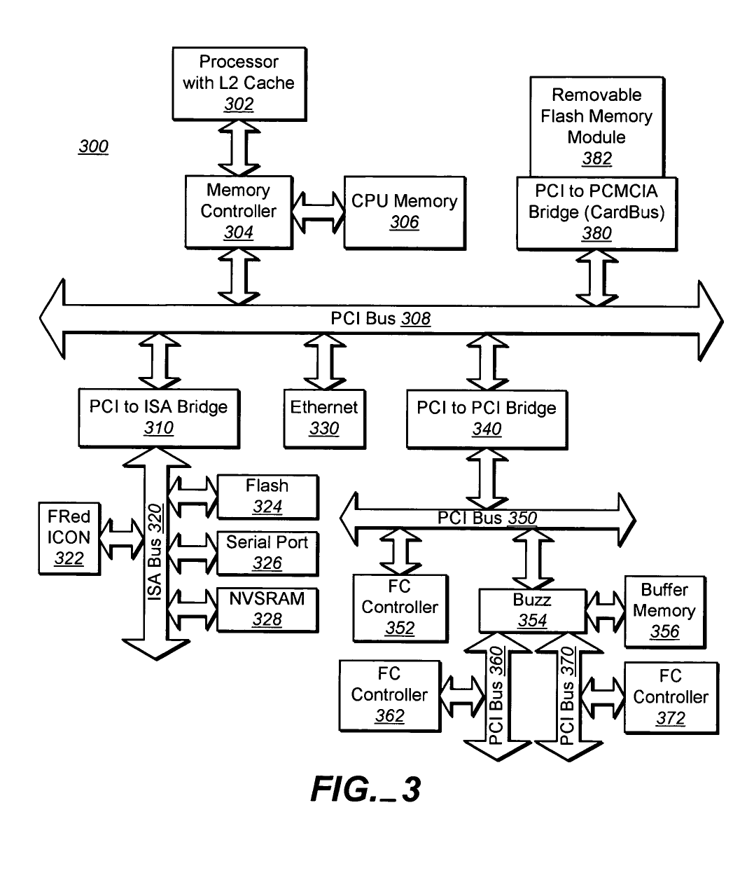

FIG. 3 is a block diagram illustrating a storage controller in accordance with a preferred embodiment of the present invention. Storage controller 300 employs a peripheral component interconnect (PCI) local bus architecture. Although the depicted example employs a PCI bus, other bus architectures such as Industry Standard Architecture (ISA) may be used. PCI bus 308 may be a 32-bit, 33 MHz bus, for example. Processor 302 and main memory 306 are connected to PCI bus 308 through memory controller 304. Processor 302 also may include cache memory, such as level two (L2) cache. Additional connections to PCI local bus 308 may be made through direct component interconnection.

In the depicted example, PCI to ISA bridge 310 connects PCI bus 308 to ISA bus 320. PCI bus 308 ma be, for example, a 32 bit, 33 MHz bus. FRed ICON 322, non-removable flash memory 324, serial port 326, and NVSRAM 328 are connected to ISA bus 320. FRed ICON is a field programmable gate array (FPGA) device used for subsystem component monitoring and for inter controller communication channels. The subsystem component monitoring channels consists of six summary fault signals, a controller active signal, sixteen subsystem monitor signals, an I2C bus for external monitoring and control, and two UPS warning signals. Ethernet adapter 330 is also connected directly to PCI bus 308. Further, PCI to PCI bridge 340 connects PCI bus 308 to PCI bus 350. PCI bus 350 may be a 64-bit, 66 MHz bus.

Buzz 354 connects PCI bus 350 to PCI bus 360 and PCI bus 370, which may also be 64-bit, 66 MHz buses, for example. Buzz is a RAID hardware module consisting of the following components: a buzz X-OR engine/shared memory chip, buzz shared memory, Rambus (up to 2 GB), and three secondary PCI devices via PCI-to-PCI bridge and buzz chips. Buffer memory 356 is connected to buzz 354. Fibre Channel (FC) controller 352 is connected directly to PCI bus 350, while FC controller 362 is connected to PCI bus 360 and FC controller 372 is connected to PCI bus 370. FC controllers 352, 362, 372 may be, for example, Tachyon DX2 FC controllers from Agilent Technologies, Inc. Each FC controller provides connection to a FC fabric through which storage controller 300 may connect with storage devices and other peripherals.

In accordance with a preferred embodiment of the present invention, PCI to PCMCIA bridge 380, also referred to as a “CardBus,” is connected to PCI bus 308. A removable non-volatile memory module, such as flash memory module 382, may be inserted in PCI to PCMCIA bridge 380 for connection to PCI bus 308. Flash memory module 382 may be a PCMCIA card, also referred to as a PC card. A PC card is typically a credit card sized peripheral that is connected to a personal computer. PC cards are plug-and-play devices and are automatically configured by “card and socket services,” which may be added to storage controller firmware. Flash memory module 382 may also have a flash file system (FFS) format for storing data.

Configuration information by be stored to flash memory module 382. Since the flash memory module is removable, this configuration information may be used with other storage controllers, uploaded to a computer device for analysis, or simply restored back to storage controller 300. Software, such as firmware, runs on processor 302 and is used to coordinate and provide control of various components within storage controller 300 in FIG. 3. Instructions for the firmware are located on storage devices, such as NVSRAM 328, and may be loaded into main memory 306 for execution by processor 302. The firmware may be modified to include card and socket services for the PCI to PCMCIA bridge and PC card. The firmware may also include interface software for invoking flash memory backup and restore and for setting flash backup parameters.

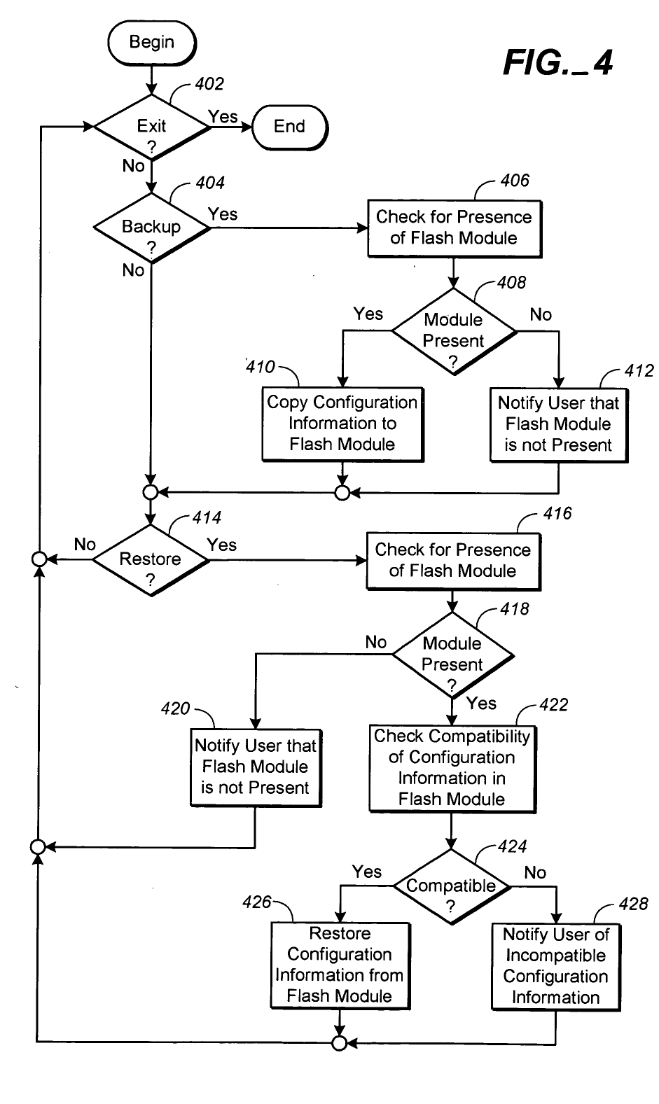

FIG. 4 is a flowchart illustrating the operation of a flash backup and restore utility within a storage controller in accordance with an exemplary embodiment of the present invention. The process begins and a determination is made as to whether an exit condition exists (step 402). An exit condition may exist when the storage controller is shut down, for example. If an exit condition exists, the process ends.

If an exit condition does not exist in step 402, a determination is made as to whether a backup operation is invoked (step 404). A backup operation may be invoked, for example, by an express command from an operator through interface software or a boot menu console. Alternatively, a backup operation may be invoked periodically by the controller software. If a backup operation is invoked, the process checks for a presence of a flash memory module (step 406). A determination is then made as to whether a flash memory module is present (step 408). If a flash memory module is present, the process copies configuration information from the storage controller to the flash memory module (step 410). Otherwise, if a flash memory module is not present in step 408, the process notifies a user that a flash memory module is not present in the storage controller (step 412).

If a backup operation is not invoked in step 404 or after the configuration is copied in step 410 or after a user is notified that a flash memory module is not present in step 412, the process continues to step 414 and a determination is made as to whether a restore operation is invoked. A restore operation may be invoked, for example, by an express command from an operator through interface software or a boot menu console. If a restore operation is invoked after verification of the presence of a valid flash memory module, the process checks for a presence of a flash memory module (step 416) and a determination is then made as to whether a flash memory module is present (step 418). If a flash memory module is not present, the process notifies a user that a flash memory module is not present in the storage controller (step 420).

If a flash memory module is present in step 418, the process checks compatibility between the storage controller and the configuration information in the flash memory module (step 422). A determination is made as to whether the configuration information is compatible with the storage controller (step 424). If the storage controller and the configuration information are compatible, the process restores the configuration information from the flash memory module to the storage controller (step 426). Otherwise, if the configuration information is not compatible with the storage controller in step 424, the process notifies the user of incompatible configuration information (step 428). If a restore operation is not invoked in step 414 or after notifying the user that a flash memory module is not present in the storage controller in step 420 or after the configuration information is restored in step 426 or after a user is notified of incompatible configuration information in step 428, the process returns to step 402 to determine whether an exit condition exists.

Thus, the present invention solves the disadvantages of the prior art by providing a removable non-volatile memory for storing configuration information in a storage controller. Configuration information may be saved to the removable non-volatile memory automatically or by express instruction from an operator. If a disaster occurs and configuration is inaccessible or corrupted, the configuration information may be restored from the removable non-volatile memory. The removable non-volatile memory may also be removed from the storage controller for insertion in another storage controller, such as a replacement controller if a storage controller fails. Furthermore, the removable non-volatile memory may be used to upload the configuration information to a computer device for analysis or communication with a support center.

As an added advantage, configuration information may be conveniently updated using the removable non-volatile memory module. For example, a technician may update configuration information at a remote location and save the configuration information onto a removable non-volatile memory module or transfer this updated configuration information to a local operator. The operator may receive a removable non-volatile memory module in the mail. This removable non-volatile memory module may then be inserted into the storage controller and the configuration may be restored quite easily. Alternatively, the operator may receive the updated configuration information from the remote technician, such as by electronic mail, for example, and save the updated configuration information to a removable non-volatile memory module. This memory module may then be inserted into the storage controller and the configuration information may be restored quickly and conveniently.

It is important to note that while the present invention has been described in the context of a fully functioning data processing system or storage controller, those of ordinary skill in the art will appreciate that the processes of the present invention are capable of being distributed in a form of a computer readable medium of instructions and in a variety of forms. Further, the present invention applies equally regardless of the particular type of signal bearing media actually used to carry out the distribution. Examples of computer readable media include recordable-type media such a floppy disc, a hard disk drive, a RAM, a CD-ROM, a DVD-ROM, and transmission-type media such as digital and analog communications links, wired or wireless communications links using transmission forms such as, for example, radio frequency and light wave transmissions. The computer readable media may take the form coded formats that are decoded for actual use in a particular data processing system.

1. A method for managing configuration information in a storage controller, the method comprising:
connecting a removable non-volatile memory module to a first storage controller; and
responsive to a given event, storing configuration information from the first storage controller to the removable non-volatile memory module.

2. The method of claim 1, wherein the given event is one of an expiration of a period of time and an express instruction from an operator.

3. The method of claim 1, wherein the given event is an express command from an operator through one of interface software and a boot menu console.

4. The method of claim 1, further comprising:
responsive to a restore event, restoring the configuration information from the removable non-volatile memory module to the first storage controller.

5. The method of claim 4, wherein the restore event is an express command from an operator through one of interface software and a boot menu console.

6. The method of claim 1, further comprising:
disconnecting the removable non-volatile memory module from the first storage controller.

7. The method of claim 6, further comprising:
connecting the removable non-volatile memory module to a second storage controller.

8. The method of claim 7, further comprising:
responsive to a restore event, restoring the configuration information from the removable non-volatile memory module to the second storage controller.

9. The method of claim 8, wherein the restore event is an express command from an operator through one of interface software and a boot menu console.

10. The method of claim 7, further comprising:
determining whether the configuration information is compatible with the second storage controller; and
responsive to the configuration information not being compatible with the second storage controller, notifying an operator of incompatible configuration information.

11. The method of claim 1, wherein the configuration information includes at least one of configuration data, firmware, bootware images, and component summary data.

12. A storage controller, comprising:
a processor;
a memory electrically coupled to the processor;
an externally accessible socket interface, wherein the externally accessible socket interface provides an electrical connection to the processor; and
a removable non-volatile memory module electrically coupled to the processor through the externally accessible socket interface,
wherein the processor, responsive to a given event, stores configuration information from the memory to the removable non-volatile memory module.

13. The storage controller of claim 12, wherein the externally accessible socket interface is a Personal Computer Memory Card International Association card slot.

14. The storage controller of claim 12, wherein the given event is one of an expiration of a period of time and an express instruction from an operator.

15. The storage controller of claim 12, wherein the configuration information includes at least one of configuration data, firmware, bootware images, and component summary data.

16. The storage controller of claim 12, wherein the removable non-volatile memory module is a flash memory module.

17. The storage controller of claim 16, wherein the flash memory module has a flash file system format for storing data.

18. An apparatus for managing configuration information in a storage controller, the apparatus comprising:
means for connecting a removable non-volatile memory module to a first storage controller; and
means, responsive to a given event, for storing configuration information from the first storage controller to the removable non-volatile memory module.

19. The apparatus of claim 18, further comprising:
responsive to a restore event, restoring the configuration information from the removable non-volatile memory module to the first storage controller.

20. The method of claim 18, further comprising:
responsive to a restore event, restoring the configuration information from the removable non-volatile memory module to a second storage controller.
